(19) United States
(12) Patent Application Publication
(10) Pub. No.: US 2024/0152520 A1
(43) Pub. Date: May 9, 2024

(54) DATA QUERY AND DATA STORAGE METHODS AND APPARATUSES FOR RELATION NETWORK

(71) Applicant: Alipay (Hangzhou) Information Technology Co., Ltd., Hangzhou (CN)

(72) Inventors: Lin Yuan, Hangzhou (CN); Zhijun Fu, Hangzhou (CN); Jin Jiang, Hangzhou (CN); Bingpeng Zhu, Hangzhou (CN)

(73) Assignee: Alipay (Hangzhou) Information Technology Co., Ltd., Hangzhou (CN)

(21) Appl. No.: 18/493,415

(22) Filed: Oct. 24, 2023

(30) Foreign Application Priority Data
Nov. 4, 2022 (CN) 202211376557.6

(51) Int. Cl. G06F 16/2457; G06F 16/22

(52) U.S. Cl. CPC G06F 16/2457; G06F 16/2255

(57) ABSTRACT

Relation network data query includes receiving a query request for an edge using a first node as a starting node, where the edge satisfies a specified filter condition comprising that the edge has a first edge data item and a corresponding first data value. Multiple index blocks associated with the first node are obtained from a non-volatile storage storing a relation network. A first index block corresponding to the first edge data item is determined from the multiple index blocks based on a correspondence between an index block and an edge data item, where the first index block comprises multiple data values of the first edge data item and location information of edges having the multiple data values and using the first node as starting nodes. Location information of an edge having the corresponding first data value is determined from the first index block and the edge obtained.

### CROSS-REFERENCE TO RELATED APPLICATIONS

This application claims priority to Chinese Patent Application No. 202211376557.6, filed on Nov. 4, 2022, which is hereby incorporated by reference in its entirety.

### TECHNICAL FIELD

One or more embodiments of this specification relate to the field of data processing technologies, and in particular, to data query and data storage methods and apparatuses for a relation network.

### BACKGROUND

A relation network is well applied to fields such as social relationship mining, product pushing, and bio-medicine. Data in these fields can be associated by using a structure of the relation network. In the relation network, a node can be used to represent an object to be expressed, and an association relationship is reflected by an edge between nodes. In actual services, data in the relation network usually need to be queried based on a specific query condition. The query condition changes flexibly, and calculation logic is sometimes relatively complex. For relation networks with very large data amounts, a common graph query method is not efficient enough. These relation networks also include many pieces of privacy data, and people hope to have higher query efficiency for the relation network without leaking the privacy data. Therefore, an improved solution is desired to improve query efficiency of data in the relation network.

### SUMMARY

One or more embodiments of this specification describe data query and data storage methods and apparatuses for a relation network, to improve query efficiency of data in the relation network. Specific technical solutions are as follows.

According to a first aspect, some embodiments provide a data query method for a relation network. The relation network is stored in a non-volatile storage, the relation network includes a plurality of nodes and edges connecting the nodes, the edges include one or more edge data items and corresponding data values, and the method is performed by a computing device, and includes the following: receiving a query request, where the query request is used to query for an edge to be queried using a first node as a starting node, where the edge to be queried satisfies a specified filter condition, and the filter condition includes that the edge to be queried has a first edge data item and a corresponding first data value; obtaining, from the storage, one or more index blocks associated with the first node; determining, from the one or more index blocks based on a correspondence between an index block and an edge data item, a first index block corresponding to the first edge data item, where the first index block includes one or more data values of the first edge data item and location information of edges having the one or more data values and using the first node as starting nodes; and determining location information of an edge having the first data value from the first index block, and obtaining the edge to be queried from the storage based on the location information of the edge.

In some implementations, the step of obtaining, from the storage, one or more index blocks associated with the first node includes the following: obtaining, from the storage, location information of the one or more index blocks associated with the first node; and the step of determining, from the one or more index blocks based on a correspondence between an index block and an edge data item, a first index block corresponding to the first edge data item includes the following: determining, from the location information of the one or more index blocks based on the correspondence between an index block and an edge data item, location information of the first index block corresponding to the first edge data item, and obtaining the first index block from the storage based on the location information.

In some implementations, the step of obtaining, from the storage, one or more index blocks associated with the first node includes the following: searching the storage for the first node, and obtaining the one or more index blocks associated with the first node based on the identified first node.

In some implementations, nodes in the storage are stored based on hash values; and the step of searching the storage for the first node includes the following: searching for the first node by using a hash value of the first node.

In some implementations, the filter condition includes that the edge to be queried has a plurality of first edge data items and corresponding first data values, and the plurality of first edge data items respectively correspond to a plurality of first index blocks; and the step of determining location information of an edge having the first data value from the first index block, and obtaining the edge to be queried from the storage based on the location information of the edge includes the following: respectively determining location information of edges having corresponding first data values from the plurality of first index blocks, to obtain a plurality of groups of edge location information, selecting an intersection set of the plurality of groups of edge location information, to obtain a location information intersection set, and obtaining the edge to be queried from the storage based on the location information intersection set.

In some implementations, the step of respectively determining location information of edges having corresponding first data values from the plurality of first index blocks includes the following: respectively determining, through asynchronous query, the location information of the edges having the corresponding first data values from the plurality of first index blocks.

In some implementations, the relation network is stored in one or more data layers of the storage, any one of the data layers is used to store a plurality of nodes and one or more associated index blocks, an edge that any one of the index blocks points to is stored in the data layer, and the method is performed for any one of the data layers.

In some implementations, the step of obtaining, from the storage, one or more index blocks associated with the first node includes the following: obtaining, from each of the one or more data layers of the storage, one or more index blocks associated with the first node in the corresponding data layer, to obtain index block groups respectively corresponding to the one or more data layers; the step of determining, from the one or more index blocks, a first index block corresponding to the first edge data item includes the following: respectively determining, from the one or more index block groups, first index blocks corresponding to first edge data items; and the step of determining location information of an edge having the first data value from the first index block, and obtaining the edge to be queried from the storage based on the location information of the edge includes the following: respectively determining location information of edges having first data values from the first index blocks corresponding to the one or more data layers; and determining the edge to be queried based on the location information of the edges determined from the one or more data layers.

In some implementations, any one of the data layers is used to store one or more data files, any one of the data files is used to store a plurality of nodes and one or more associated index blocks, an edge that any one of the index blocks points to is stored in the data file, and the method is performed for any one of the data files.

According to a second aspect, some embodiments provide a data storage method for a relation network. The relation network includes a plurality of nodes and edges connecting the nodes, the edges include one or more edge data items and corresponding data values, and the method is performed by a computing device and used to store the edges in the relation network in a non-volatile storage, and includes the following: receiving a storage request, where the storage request is used to store a first edge using a first node as a starting node in the storage, and the first edge includes a first edge data item and a corresponding data value; storing the first edge in the storage, and determining location information of the first edge; obtaining, from the storage, one or more index blocks associated with the first node; determining, from the one or more index blocks based on a correspondence between an index block and an edge data item, a first index block corresponding to the first edge data item; and recording the data value of the first edge data item and the location information of the first edge in the first index block.

In some implementations, the step of obtaining, from the storage, one or more index blocks associated with the first node includes the following: obtaining, from the storage, locations to be written of the one or more index blocks associated with the first node; and the step of determining, from the one or more index blocks based on a correspondence between an index block and an edge data item, a first index block corresponding to the first edge data item includes the following: determining, from the locations to be written of the one or more index blocks based on the correspondence between an index block and an edge data item, a location to be written of the first index block corresponding to the first edge data item.

In some implementations, the step of obtaining, from the storage, one or more index blocks associated with the first node includes the following: searching the storage for the first node, and obtaining the one or more index blocks associated with the first node based on the identified first node.

In some implementations, the relation network is stored in one or more data layers of the storage, and one of the data layers is used to store a plurality of nodes and one or more associated index blocks, the storage request is used to store the first edge in a first data layer of the storage, and the method is performed for the first data layer.

In some implementations, any one of the data layers is used to store one or more data files, any one of the data files is used to store a plurality of nodes and one or more associated index blocks, the storage request is used to store the first edge in a first data file of the first data layer, and the method is performed for the first data file.

According to a third aspect, some embodiments provide a data query apparatus for a relation network. The relation network is stored in a non-volatile storage, the relation network includes a plurality of nodes and edges connecting the nodes, the edges include one or more edge data items and corresponding data values, and the apparatus is deployed in a computing device, and includes: a first receiving module, configured to receive a query request, where the query request is used to query for an edge to be queried using a first node as a starting node, where the edge to be queried satisfies a specified filter condition, and the filter condition includes that the edge to be queried has a first edge data item and a corresponding first data value; a first acquisition module, configured to obtain, from the storage, one or more index blocks associated with the first node; a first determining module, configured to determine, from the one or more index blocks based on a correspondence between an index block and an edge data item, a first index block corresponding to the first edge data item, where the first index block includes one or more data values of the first edge data item and location information of edges having the one or more data values and using the first node as starting nodes; and a second acquisition module, configured to determine location information of an edge having the first data value from the first index block, and obtain the edge to be queried from the storage based on the location information of the edge.

According to a fourth aspect, some embodiments provide a data storage apparatus for a relation network. The relation network includes a plurality of nodes and edges connecting the nodes, the edges include one or more edge data items and corresponding data values, and the apparatus is deployed in a computing device, is configured to store the edges in the relation network in a non-volatile storage, and includes: a second receiving module, configured to receive a storage request, where the storage request is used to store a first edge using a first node as a starting node in the storage, and the first edge includes a first edge data item and a corresponding data value; a first storage module, configured to store the first edge in the storage, and determine location information of the first edge; a third acquisition module, configured to obtain, from the storage, one or more index blocks associated with the first node; a second determining module, configured to determine, from the one or more index blocks based on a correspondence between an index block and an edge data item, a first index block corresponding to the first edge data item; and a first recording module, configured to record the data value of the first edge data item and the location information of the first edge in the first index block.

According to a fifth aspect, some embodiments provide a computer-readable storage medium. The computer-readable storage medium stores a computer program, and when the computer program is executed in a computer, the computer is enabled to perform the method according to either of the first aspect and the second aspect.

According to a sixth aspect, some embodiments provide a computing device, including a storage and a processor. The storage stores executable code, and when executing the executable code, the processor implements the method according to either of the first aspect and the second aspect.

In the methods and the apparatuses provided in the embodiments of this specification, when the edge using a first node as a starting node is queried for, the index blocks associated with the first node can be obtained from the storage, the first index block corresponding to the first edge data item is determined from the index blocks based on the filter condition, the location information of the edge having the first data value is determined from the first index block, and the edge to be queried is obtained from the storage based on the location information of the edge. In the embodiments of this specification, a node, degree-1 edges of the node, and degree-1 edge indexes are associatively stored together, so that an edge satisfying the filter condition in the degree-1 edges of the node can be quickly identified, thereby improving query efficiency of data in the relation network.

### BRIEF DESCRIPTION OF DRAWINGS

To describe the technical solutions in embodiments of this application more clearly, the following briefly describes the accompanying drawings needed for describing the embodiments. Clearly, the accompanying drawings in the following description merely illustrate some embodiments of this application, and a person of ordinary skill in the art can derive other drawings from these accompanying drawings without creative efforts.

FIG. 1 is a schematic diagram illustrating an implementation scenario, according to some embodiments disclosed in this specification;

FIG. 2 is a schematic flowchart illustrating a data query method for a relation network, according to some embodiments;

FIG. 3 is a schematic diagram illustrating a structure of an index block and an edge data block that are associated with a node;

FIG. 4 is a schematic diagram illustrating a storage structure of a node and an edge;

FIG. 5 is a schematic flowchart illustrating a data storage method for a relation network, according to some embodiments;

FIG. 6 is a schematic block diagram illustrating a data query apparatus for a relation network, according to some embodiments; and

FIG. 7 is a schematic block diagram illustrating a data storage apparatus for a relation network, according to some embodiments.

### DESCRIPTION OF EMBODIMENTS

The solutions provided in this specification are described below with reference to the accompanying drawings.

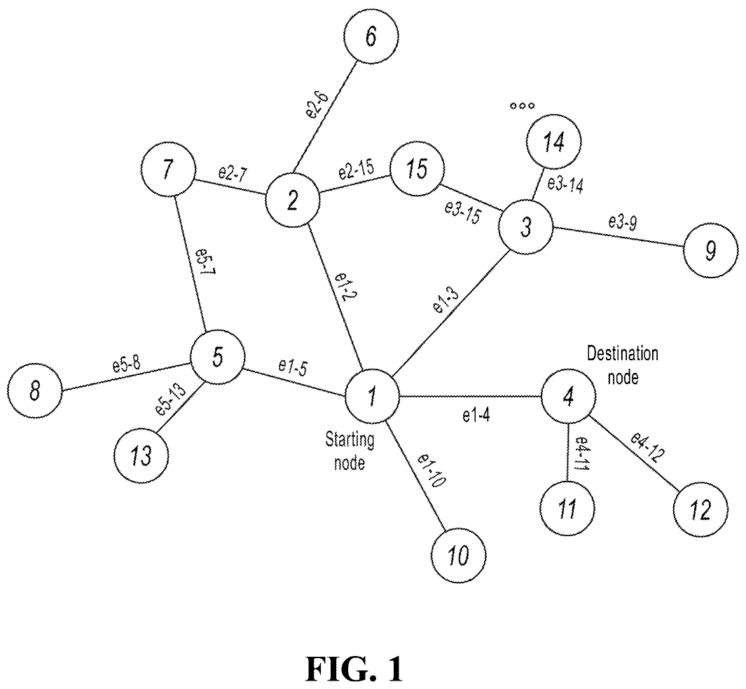

FIG. 1 is a schematic diagram illustrating an implementation scenario, according to some embodiments disclosed in this specification. The figure is a schematic diagram illustrating relationships between some nodes and edges in a certain relation network. A circle with a number represents a node, a line between nodes represents an edge between the nodes, and the edge between the nodes reflects an association relationship between the nodes. When data in the relation network are queried, it is often needed to query degree-1 edges of a node based on a filter condition (also referred to as a query condition). For example, for node 1, edges e1-2, e1-3, e1-4, e1-5, and e1-10 that are directly connected to node 1 are degree-1 edges of node 1. When degree-1 edge data of the node are stored, degree-1 edge indexes of the node can be established, and the degree-1 edge indexes are stored associatively with the node. When the degree-1 edge indexes are established, corresponding index blocks can be established for different edge data items. As such, when the degree-1 edges of the node are queried, an edge satisfying the filter condition can be determined by using degree-1 edge index blocks of the node.

One or more edges, for example, different types of edges established at different moments, can be included between two nodes. Therefore, edge data can be relatively rich, and the edge can include one or more edge data items and corresponding data values. For example, the edge data items can include a timestamp of the edge, a starting node and a destination node of the edge, an edge type, and various attributes of the edge. The attributes of the edge can include a direction of the edge, a validity period of the edge, etc. There can be a plurality of filter conditions. Corresponding filter conditions can be set for different edge data items. For example, an edge using node 1 as a starting node and node 2 as a destination node and having a timestamp of 8:00 to 10:00 needs to be queried for. In each time of query, the filter condition changes flexibly, and calculation logic is relatively complex. In addition, an edge between nodes can be directional, or can be non-directional. For a same edge, each of two nodes connected by the edge can be used as a starting node, and data of the edge can be identified regardless of which node is used as a starting node.

Graph data such as nodes and edges can be stored in forms of a plurality of data structures. For example, the graph data can be stored in a form of a data file by using a structure of a plurality of data layers. A log structured merge tree (LSM tree) is a storage architecture using this data structure. The LSM tree is a hierarchical, ordered, and disk-oriented data structure. The LSM tree is only an implementation of storing data of the relation network in the form of a data file by using the structure of a plurality of data layers. In practice, there are other implementations, which are not enumerated in this specification. Data in the relation network dynamically increase, and data may be written constantly. Organization formats of the data can be stored in layers based on the structure of a plurality of data layers, and the layers can include a memory layer and a file layer. The file layer is located in a disk. Data to be stored are first stored in the memory layer, and then are merged into a file by a background merge thread and belong to the file layer. Each of the memory layer and the file layer can include a plurality of data layers. All edges of a node may exist at each data layer.

Therefore, when there are a massive quantity of nodes and edges in the relation network, a process of querying degree-1 edges of a node is relatively time-consuming and labor-consuming. In addition, protection of privacy data also needs to be considered during graph data query. In a common query method, all edges of the node are queried and stored in a memory, and an edge satisfying a condition is selected based on a filter condition. However, when searching is performed on each data layer in this method, a time and complexity are relatively large, and query efficiency needs to be improved.

To improve data query efficiency, some embodiments of this specification provide a data query method for a relation network, and correspondingly, also provide a data storage method. In other words, a data processing process of the relation network in the embodiments of the specification includes a data storage phase and a data query phase. To more directly reflect efficiency improvement of the data query process, the following first describes the data query phase and then describes the data storage phase.

The data query method includes the following steps: Step S210: Receive a query request, where the query request is used to query for an edge to be queried using a first node as a starting node, where the edge to be queried needs to satisfy a specified filter condition, and the filter condition includes that the edge to be queried has a first edge data item and a corresponding first data value. Step S220: Obtain, from a storage, one or more index blocks associated with the first node. Step S230: Determine, from the one or more index blocks based on a correspondence between an index block and an edge data item, a first index block corresponding to the first edge data item, where the first index block includes one or more data values of the first edge data item and location information of edges having the one or more data values and using the first node as starting nodes. Step S240: Determine location information of an edge having the first data value from the first index block, and obtain the edge to be queried from the storage based on the location information of the edge.

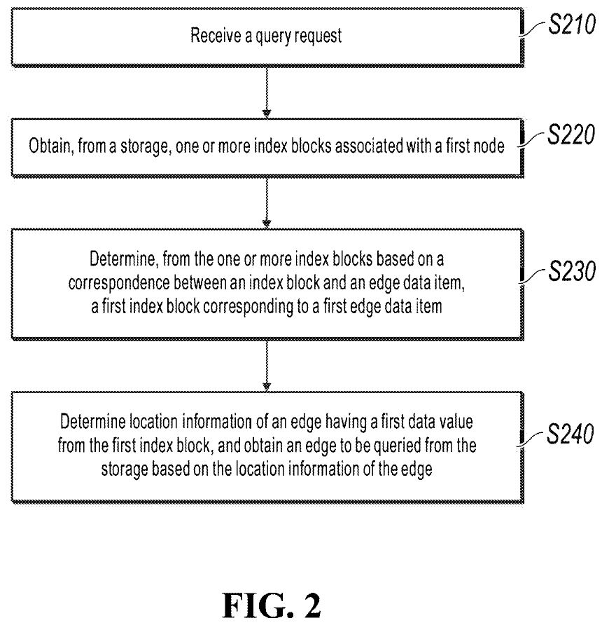

In the embodiments, the location information of the edge satisfying the filter condition is quickly determined by using the index blocks of the degree-1 edges associated with the node, and the edge to be queried is directly obtained from the storage based on the location information, without traversing all edges of the node. Therefore, query efficiency can be improved. The following describes the embodiments in detail with reference to FIG. 2.

FIG. 2 is a schematic flowchart illustrating a data query method for a relation network, according to some embodiments. The relation network is stored in a non-volatile storage, and the non-volatile storage can be, for example, a storage such as a disk, a hard disk, or a flash memory. The non-volatile storage is opposite to a volatile storage such as a memory. A small part of data of the relation network can be stored in the memory, and most of the data are stored in the disk. The relation network includes a plurality of nodes and edges connecting the edges, and the edges include one or more edge data items and corresponding data values. The method is performed by a computing device. Specifically, the method can be performed by a CPU in the computing device. The computing device can be implemented by any apparatus, device, platform, device cluster, etc. having computing and processing capabilities. The method includes the following steps.

In step S210, a query request is received.

The query request is used to query for an edge to be queried using a first node as a starting node. The first node is any one of the plurality of nodes, for example, can be represented by node 1. The query request can include a filter condition that the edge to be queried needs to satisfy. The filter condition can be set by a user, or can be generated by the execution device based on other information. The filter condition includes that the edge to be queried has a first edge data item and a corresponding first data value. The edge data item can include a timestamp, a starting node, a destination node, an edge type, one or more attributes of the edge, etc. In payment scenarios, the edge type can include, for example, transfer, borrowing, repayment, or consumption. The first edge data item can be one or more of the above-mentioned edge data items. Data can be stored in a form of a key value (KV) pair. Therefore, the first edge data item can be understood as a key, and a corresponding first data value can be understood as a value. For example, the filter condition can be querying for an edge using node 1 as a starting node and having a timestamp of 8:00 to 10:00, or querying for an edge using node 1 as a starting node and node 2 as a destination node.

The query request can be obtained based on a user operation, can be sent by another device to the computing device, or can be sent by another module in the computing device to the CPU, or there can be any other possible method.

In step S220, one or more index blocks associated with the first node are obtained from the storage.

In the embodiments, each node (for example, node 1) can correspond to one or more associated index blocks, and the index block can include one or more data values of a corresponding edge data item and location information of edges having the one or more data values and using the node (for example, node 1) as starting nodes. In other words, one index block can correspond to one edge data item, and the index block includes a correspondence between one or more data values of the edge data item and location information of edges. The location information of the edges is location information of edges using the node (for example, node 1) as starting nodes.

When one or more index blocks are obtained from the storage, the storage can be directly searched for the index blocks associated with the first node, and the identified index blocks can be read. In these implementations, data of one or more index blocks associated with the first node are directly read from the storage.

To avoid reading unnecessary index block data and reduce an IO data amount, location information of the index blocks associated with the first node can be read first, and index block data needed can be pertinently read based on the location information of the index blocks. In step S220, the location information of the one or more index blocks associated with the first node can be obtained from the storage. In other words, in this step, index block data are not directly obtained, but the location information of the index blocks associated with the first node is first obtained.

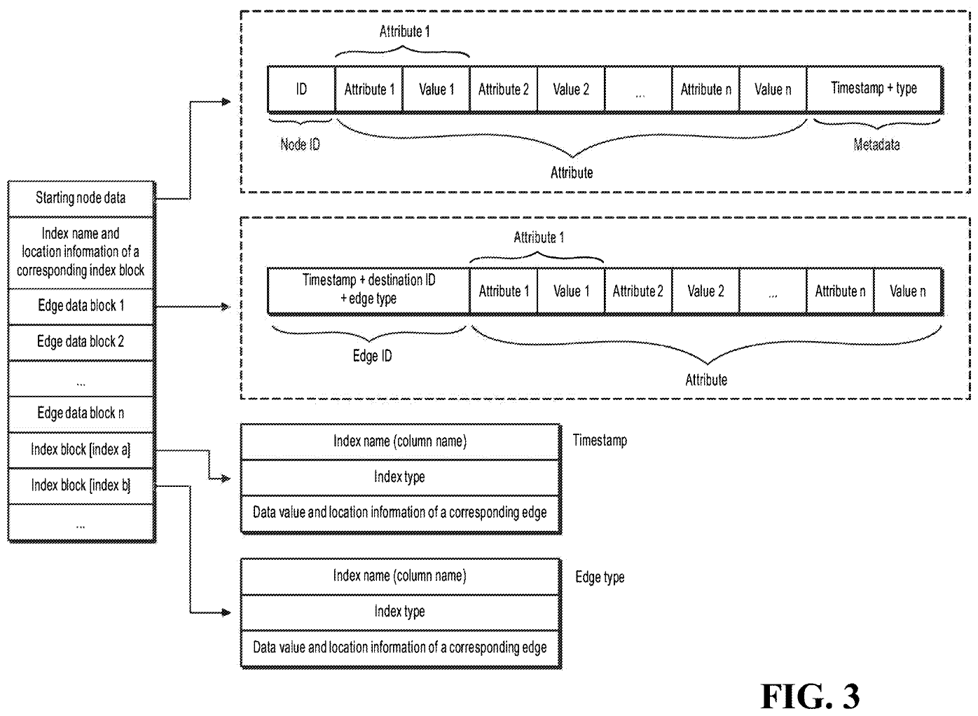

FIG. 3 is a schematic diagram illustrating a structure of an index block and an edge data block that are associated with a node. Index blocks associated with node 1 include an index block (index a) corresponding to the timestamp, an index block (index b) corresponding to the edge type, an index block (not shown in the figure) corresponding to the destination node (dstld), etc. There is a correspondence between an index block and an edge data item, and edge location information stored in the index block is associated with a corresponding edge data item. For example, data stored in the index block corresponding to the timestamp include location information of edges corresponding to different timestamps and using node 1 as starting nodes, for example, location information of edge e1-5 at 8:00, location information of edge e1-3 at 8:10, and location information of edge e1-10 at 9:00.

The index block can be understood as an index data block, and is a data block that includes one or more pieces of index data. The index block can include content such as an index name, an index type, a data value, and location information of a corresponding edge. The index name is a column name of the index block, and the index type is a data type of an index, for example, can be an integer (int) type, a double type, or a string type.

The edge location information can include an offset, a data length, etc. of an edge. The edge location information is information about a location where data of the edge are stored. The data of the edge can include an edge identifier (ID), an attribute (referring to FIG. 3), etc. The edge ID can be identified by using a timestamp, a destination ID, and an edge type. There can be a plurality of attributes. The data of the edge can be stored in an edge data block, and one edge data block can include data of a plurality of edges. When there are a relatively large quantity of edges, a plurality of edge data blocks can be used for storage.

FIG. 3 further illustrates node data. The node data can include a node ID, an attribute, metadata, etc. The metadata can include a timestamp, a type, etc. of a node. Starting node data include a starting node ID, an attribute, metadata, etc. The starting node data can be stored together with location information of an associated index block. For example, the starting node data, an index name, and location information of a corresponding index block can be stored together. When the node is identified, the node and location information of an associated index block can be directly read. The data format illustrated in FIG. 3 is merely an example, and does not constitute a limitation on this application.

In some implementations, the nodes stored in the storage can be stored based on hash values. For example, a hash value of a node can be calculated by using a node ID. When the one or more index blocks associated with the first node are obtained from the storage, the storage can be searched for the first node, and the one or more index blocks associated with the first node can be obtained based on the identified first node. For example, the first node can be quickly searched for by using a hash value of the first node, so that the first node can be quickly identified. A node and location information of an index block are stored together, so that the location information of the index block can be directly obtained when the node is identified, thereby improving data reading efficiency.

In step S230, a first index block corresponding to the first edge data item is determined from the one or more index blocks based on a correspondence between an index block and an edge data item.

The first index block includes one or more data values of the first edge data item and location information of edges having the one or more data values and using the first node as starting nodes. When there are a plurality of first edge data items, a plurality of first index blocks can be determined.

When the data of the one or more index blocks are obtained in step S220, the first index block including the location information of the edges can be directly obtained from the one or more index blocks in step S230.

When the location information of the one or more index blocks is obtained in step S220, in step S230, location information of the first index block corresponding to the first index block can be determined from the location information of the one or more index blocks based on the correspondence between an index block and an edge data item, and the first index block can be obtained from the storage based on the location information. In these implementations, location information of an index block needed can be first determined from location information of a plurality of index blocks, and a corresponding index block can be obtained by using the location information, without obtaining unnecessary index block data, so that an amount of data read from the storage can be reduced.

In step S240, location information of an edge having the first data value is determined from the first index block, and the edge to be queried is obtained from the storage based on the location information of the edge. Data of the first index block include a correspondence between one or more data values and location information of an edge. Therefore, the location information of the edge corresponding to the first data value can be determined from the data of the first index block. Edge data needed can be directly obtained when the location information of the edge is obtained.

In some implementations, the filter condition can include two or more first edge data items. In other words, the filter condition includes that the edge to be queried has a plurality of first edge data items and corresponding first data values, and the plurality of first edge data items respectively correspond to a plurality of first index blocks. For example, an edge using node 1 as a starting node and having a timestamp of 8:00 to 10:00 and an edge type of transfer needs to be queried for. The first edge data item here includes two filter conditions: the timestamp and the edge type.

In step S240, location information of edges having corresponding first data values can be respectively determined from the plurality of first index blocks, to obtain a plurality of groups of edge location information, an intersection set of the plurality of groups of edge location information is selected, to obtain a location information intersection set, and the edge to be queried is obtained from the storage based on the location information intersection set. For example, edge location information (location information 1) having the timestamp of 8:00 to 10:00 can be determined from edge location information included in a timestamp index block, edge location information (location information 2) having the edge type of transfer can be determined from edge location information included in an edge type index block, and an intersection set of location information 1 and location information 2 can be selected. The obtained location information intersection set satisfies the two filter conditions. As such, unnecessary edge data may not be obtained, and a relatively small quantity of pieces of edge data can be read from the storage.

The plurality of index blocks can be independently stored in a form of a column, and can be respectively read. To improve reading efficiency, the location information of the edges having the corresponding first data values can be respectively determined from the one or more first index blocks through asynchronous query. In other words, for the plurality of first index blocks, a reading operation is concurrently performed by using a plurality of threads, so that processing efficiency is improved.

When data of the relation network are stored, a part of data are further stored in the volatile storage. For example, a part of data (newly added or updated data) can be first written into a memory layer, and then merged into a file layer of the disk when a specific condition is satisfied. Therefore, when edges satisfying the filter condition and using the first node as starting nodes need to be searched for, the memory can be searched for all edges using the first node as starting nodes, edges satisfying the filter condition are selected from these edges, and the edge to be queried can be obtained based on these edges and the edge corresponding to the location information of the edge obtained in step S240.

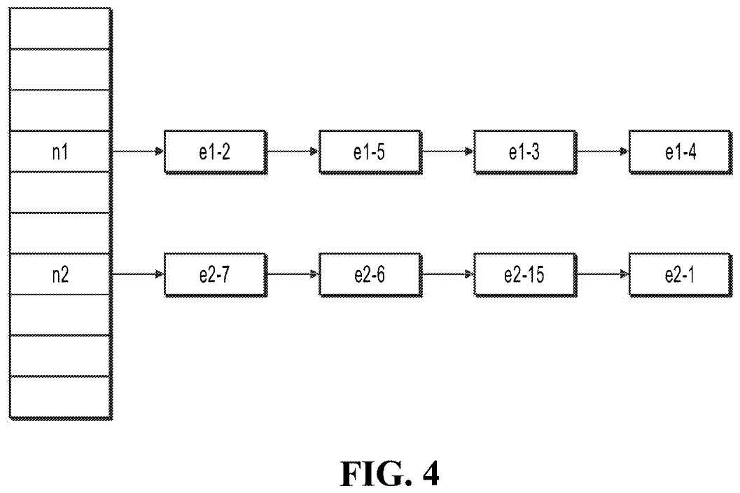

FIG. 4 is a schematic diagram illustrating a storage structure of a node and an edge. Data of nodes and edges in the memory layer can be stored based on the example in FIG. 4. A column on the left is used to store node data, and a column on the right is edges associated with the node. A node can be stored based on a hash value of a node ID, so that the node can be quickly identified. Edges of a same node can be written into a linked list. In FIG. 4, edges using node n1 as starting nodes include e1-2, e1-5, e1-3, e1-4, etc., and edges using node n2 as starting nodes include e2-7, e2-5, e2-15, e2-1, etc. Because there are fewer data in the memory layer, data of all edges using the first node as starting nodes can be directly read, and operations such as decryption and decryption can be performed on the data of the edges to filter out a target edge.

In some implementations, data of the relation network stored in the storage can be stored based on a structure of a data layer. Any data layer is used to store a plurality of nodes and one or more associated index blocks, and an edge that any one of the index blocks points to is stored in the data layer. In other words, an edge corresponding to location information included in an index block is stored in a data layer where the index block is located. Therefore, steps S220 to S240 can be performed for any data layer. Different data layers can include different edges of a node. After edges satisfying the filter condition are selected from different data layers, the edge to be queried can be determined based on the edges obtained from the different data layers. Or, location information of edges satisfying the filter condition is selected from different data layers, location information of the edge to be queried is determined based on the location information of these edges, and data of the edge are read from a corresponding data layer by using the location information.

In these implementations, in step S220, one or more index blocks associated with the first node in each of the one or more data layers of the storage can be obtained from the corresponding data layer, to obtain index block groups respectively corresponding to the one or more data layers.

In step S230, first index blocks corresponding to first edge data items can be respectively determined from the one or more index block groups based on the correspondence between an index block and an edge data item.

In step S240, location information of edges having first data values can be respectively determined from the first index blocks corresponding to the one or more data layers, and the edge to be queried can be determined based on the location information of the edges determined from the one or more data layers. For example, corresponding edges can be obtained from corresponding data layers based on the location information of the edges, and the edge to be queried can be determined based on the obtained edges of the different data layers. Edges obtained from different data layers can be duplicate or be of the latest version. In this case, the edge to be queried can be determined from the edges corresponding to the different data layers based on recorded metadata.

In some implementations, when a data amount of the relation network is massive, data of the relation network stored in the storage can be stored in a form of a data file based on a structure of a data layer. In a data layer, data of nodes and edges can be respectively stored in one or more data files (for example, bin files). For example, data of node 1 and degree-1 edges of node 1 are stored in a bin1 file, and data of node 2 and degree-1 edges of node 2 are stored in a bin2 file. Any data layer can be used to store one or more data files, one of the data files can be used to store a plurality of nodes and one or more associated index blocks, and an edge that one of the index blocks points to is stored in a data file where the index block is located. In other words, an edge corresponding to location information included in an index block is stored in a data file where the index block is located. Generally, in a data layer, a node and degree-1 edges of the node are stored in a same data file. Therefore, steps S220 to S240 can be performed for any data file. Different data files can include degree-1 edges of different nodes. When there are a plurality of first nodes, and the plurality of first nodes are respectively stored in different data files at a certain data layer, after edges satisfying the filter condition are selected from the different data files, the edges obtained from the different data files can be used as edges that belong to the data layer where the different data files are located. If the plurality of first nodes are respectively stored in a plurality of data layers, when edges of different data layers are obtained, the edges obtained from the different data layers can be processed, for example, merged, so that the final edge to be queried is determined.

In these implementations, when there are a plurality of first nodes, and the plurality of first nodes are respectively stored in one or more data files of one data layer (for example, level0), in step S220, one or more index blocks associated with the first nodes in each of the one or more data files of the data layer level0 can be respectively obtained from the corresponding data file, to obtain index block groups respectively corresponding to the one or more data files.

In step S230, first index blocks corresponding to first edge data items can be respectively determined from the one or more index block groups based on the correspondence between an index block and an edge data item. Each first node can correspond to different first edge data items.

In step S240, location information of edges having first data values can be respectively determined from first index blocks corresponding to the one or more data files, and the edge to be queried can be determined based on the location information of the edges determined from the one or more data files. For example, edge 1, edge 2, and edge 3 of node 1 are determined from a bin1 file of the data layer level0, and edge 4 and edge 5 of node 2 are determined from a bin2 file, to determine that edges to be queried of node 1 and node 2 of the data layer level0 include edge 1 to edge 5. In this method, edges to be queried of a data layer level1, edges to be queried of level2, etc. are respectively obtained, and a set of these edges to be queried is determined as final edges to be queried. Or, the final edge to be queried is selected from edges to be queried corresponding to a plurality of data layers based on recorded metadata.

The above-mentioned implementations are also applicable when degree-1 edges of a node are stored in different data files or stored in different data layers.

In an LSM tree, starting node data, location information of an index block, an edge data block, and an index block can be correspondingly stored in a same data layer, or correspondingly stored in a same data file.

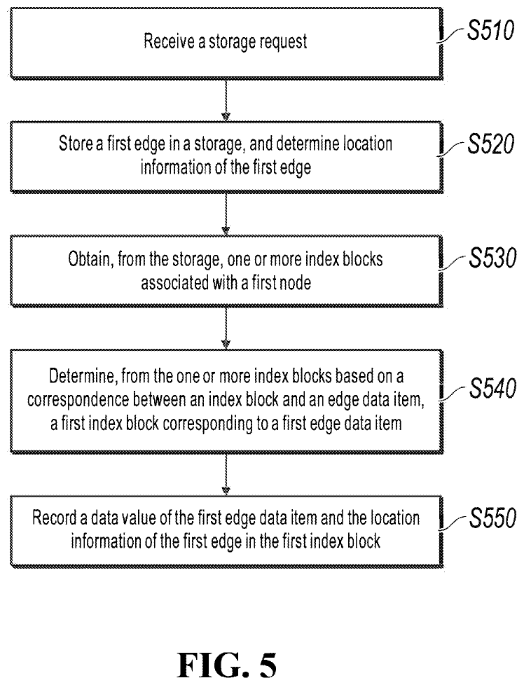

The above-mentioned embodiments describe the data query phase. The following describes the data storage phase with reference to embodiments in FIG. 5. Index data used in the data query phase can be established in the data storage phase. The embodiments in FIG. 5 and the embodiments in FIG. 2 are methods at different phases obtained based on the same inventive concept, and mutual references can be made to related descriptions.

FIG. 5 is a schematic flowchart illustrating a data storage method for a relation network, according to some embodiments. The relation network includes a plurality of nodes and edges connecting the edges, and the edges include one or more edge data items and corresponding data values. The method can be performed by a computing device. The method is used to store the edges in the relation network in a non-volatile storage, and specifically includes the following step S510 to S550.

In step S510, a storage request is received.

The storage request is used to store a first edge using a first node as a starting node in the non-volatile storage, the first edge includes a first edge data item and a corresponding data value, and the data belong to data of the first edge. The first node is any node. There can be one or more first edge data items. The first edge can be stored after storage of the first node is completed, or can be stored in the storage together with the first node as requested.

The storage request can be obtained based on a user operation, can be sent by another device to the computing device, or can be sent by another module in the computing device to a CPU, or there can be any other possible method.

In step S520, the first edge is stored in the storage, and location information of the first edge is determined. This step can be performed based on an existing storage method. Details are omitted here for simplicity.

In step S530, one or more index blocks associated with the first node are obtained from the storage. When the first node is stored in the storage, the one or more index blocks associated with the first node can be established, and locations to be written of the one or more index blocks are recorded. The locations to be written are locations to be written in the storage. A quantity of index blocks can be set as needed.

After the one or more index blocks are established, the locations to be written of the one or more index blocks associated with the first node can be directly obtained from the storage as needed.

When nodes stored in the storage are stored based on hash values, the storage can be searched for the first node based on a hash value of the first node, and the locations to be written of the one or more index blocks associated with the first node can be obtained based on the identified first node. The locations to be written can be recorded in location information of the index blocks.

In step S540, a first index block corresponding to the first edge data item is determined from the one or more index blocks based on a correspondence between an index block and an edge data item.

When the locations to be written of the one or more index blocks are obtained in step S530, in step S540, a location to be written of the first index block corresponding to the first edge data item can be determined from the locations to be written of the one or more index blocks based on the correspondence between an index block and an edge data item.

In step S550, the data value of the first edge data item and the location information of the first edge are recorded in the first index block. Specifically, the data value of the first edge data item and the location information of the first edge can be recorded in the first index block based on the location to be written of the first index block.

When the relation network is stored in the above-mentioned storage based on a structure of a data layer, the storage request is used to store the first edge in a first data layer of the storage. The first data layer is any data layer, for example, can be an upper data layer or a lower data layer in the storage. The storage request can be generated when data in a memory layer need to be merged into a file layer, or can be generated when merging is performed from an upper data layer in the file layer into a lower data layer. Steps S520 to S550 can be performed for the first data layer.

In these implementations, in step S520, the first edge can be stored in the first data layer, and location information of the first edge in the first data layer can be determined. In step S530, the one or more index blocks associated with the first node are obtained from the first data layer.

In some implementations, data of the relation network stored in the storage can be stored in a form of a data file based on the structure of a data layer. In a data layer, data of nodes and edges can be stored in one or more data files (for example, bin files). Generally, in a data layer, a node and degree-1 edges of the node can be stored in a same data file. The above-mentioned storage request is used to store the first edge in a first data file of the first data layer, and the first data file can be any data file of the first data layer. Steps S520 to S550 can be performed for the first data file.

In these implementations, in step S520, the first edge can be stored in the first data file, and location information of the first edge in the first data file can be determined. In step S530, the one or more index blocks associated with the first node are obtained from the first data file.

In the embodiments, when edge data are stored in a disk, index data can be established based on an edge data item corresponding to a specified index block, so that processing efficiency is improved during edge data query.

In the data query method provided in the above-mentioned embodiments, edge data do not need to be queried at a time, but locations of edges satisfying a filter condition are obtained by using the condition, and a data amount of locations of edges is very small. When data are stored by using a plurality of data layers, operations of reading edges from the plurality of data layers can be asynchronously performed. There is no need to query an upper layer to check whether data at a current layer is latest data, and during merging, which data are latest data can be determined based on metadata, so that CPU resources can be reduced. Data of a node and index data of degree-1 edges of the node are stored together, so that all edges of the node that satisfy a condition can be positioned based on a hash value of a node ID, thereby performing quick and pertinent edge search. There is no need to read useless edge data or decode and decrypt edge data before an edge needed is selected. Therefore, query efficiency can be improved.

In this specification, “first” in words such as a first node, a first edge data item, a first data value, and a first index block, and “second” in the specification are merely intended for distinguishing and ease of description, and are not of any limiting significance.

Specific embodiments of this specification have been described above, and other embodiments fall within the scope of the appended claims. In some situations, the actions or steps described in the claims can be performed in an order different from the order in the embodiments and the desired results can still be achieved. In addition, processes described in the accompanying drawings do not necessarily require a specific order or a sequential order shown to achieve the desired results. In some implementations, multitasking and parallel processing are also possible or may be advantageous.

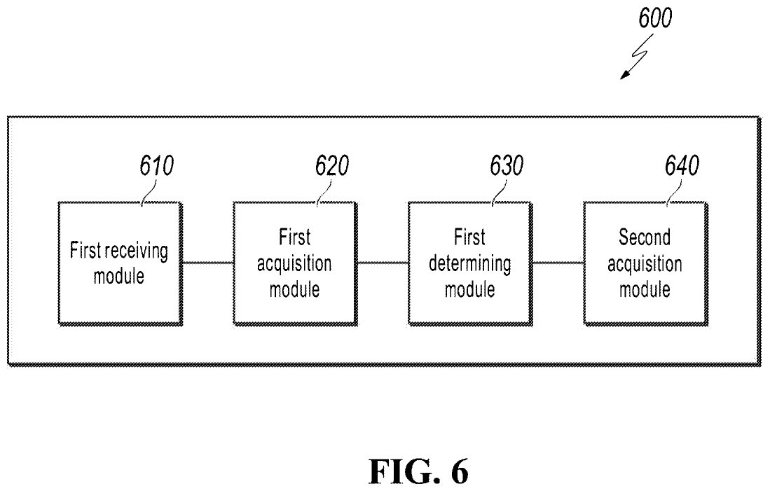

FIG. 6 is a schematic block diagram illustrating a data query apparatus for a relation network, according to some embodiments. The apparatus embodiments correspond to the method embodiments shown in FIG. 2. The relation network is stored in a non-volatile storage. The relation network includes a plurality of nodes and edges connecting the edges, and the edges include one or more edge data items and corresponding data values. The apparatus 600 is deployed in a computing device, and includes: a first receiving module 610, configured to receive a query request, where the query request is used to query for an edge to be queried using a first node as a starting node, where the edge to be queried satisfies a specified filter condition, and the filter condition includes that the edge to be queried has a first edge data item and a corresponding first data value; a first acquisition module 620, configured to obtain, from the storage, one or more index blocks associated with the first node; a first determining module 630, configured to determine, from the one or more index blocks based on a correspondence between an index block and an edge data item, a first index block corresponding to the first edge data item, where the first index block includes one or more data values of the first edge data item and location information of edges having the one or more data values and using the first node as starting nodes; and a second acquisition module 640, configured to determine location information of an edge having the first data value from the first index block, and obtain the edge to be queried from the storage based on the location information of the edge.

In some implementations, the first acquisition module 620 is specifically configured to: obtain, from the storage, location information of the one or more index blocks associated with the first node; and the first determining module is specifically configured to: determine, from the location information of the one or more index blocks based on the correspondence between an index block and an edge data item, location information of the first index block corresponding to the first edge data item, and obtain the first index block from the storage based on the location information.

In some implementations, the first acquisition module 620 is specifically configured to: search the storage for the first node, and obtain the one or more index blocks associated with the first node based on the identified first node.

In some implementations, nodes in the storage are stored based on hash values; and that the first acquisition module 620 searches the storage for the first node includes the following: searching for the first node by using a hash value of the first node.

In some implementations, the filter condition includes that the edge to be queried has a plurality of first edge data items and corresponding first data values, and the plurality of first edge data items respectively correspond to a plurality of first index blocks; and the second acquisition module 640 is specifically configured to: respectively determine location information of edges having corresponding first data values from the plurality of first index blocks, to obtain a plurality of groups of edge location information, select an intersection set of the location information of the plurality of edges, to obtain a location information intersection set, and obtain the edge to be queried from the storage based on the location information intersection set.

In some implementations, that the second acquisition module 640 respectively determines the location information of the edges having the corresponding first data values from the plurality of first index blocks includes the following: respectively determining, through asynchronous query, the location information of the edges having the corresponding first data values from the plurality of first index blocks.

In some implementations, the relation network is stored in one or more data layers of the storage, any one of the data layers is used to store a plurality of nodes and one or more associated index blocks, an edge that any one of the index blocks points to is stored in the data layer, and the method is performed for any one of the data layers.

In some implementations, the first acquisition module 620 is specifically configured to: obtain, from each of the one or more data layers of the storage, one or more index blocks associated with the first node in the corresponding data layer, to obtain index block groups respectively corresponding to the one or more data layers; the first determining module 630 is specifically configured to: respectively determine, from the one or more index block groups based on the correspondence between an index block and an edge data item, first index blocks corresponding to first edge data items; and the second acquisition module 640 includes: a first determining submodule (not shown in the figure), configured to respectively determine location information of edges having first data values from the first index blocks corresponding to the data layers; and a first acquisition submodule (not shown in the figure), configured to determine the edge to be queried based on the location information of the edges determined from the one or more data layers.

In some implementations, any one of the data layers is used to store one or more data files, any one of the data files is used to store a plurality of nodes and one or more associated index blocks, an edge that any one of the index blocks points to is stored in the data file, and the method is performed for any one of the data files.

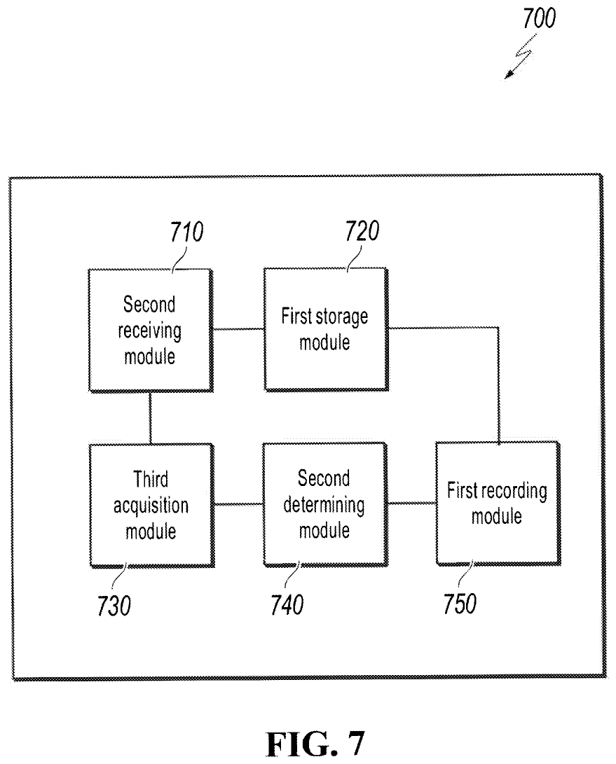

FIG. 7 is a schematic block diagram illustrating a data storage apparatus for a relation network, according to some embodiments. The apparatus embodiments correspond to the method embodiments shown in FIG. 5. The relation network includes a plurality of nodes and edges connecting the nodes, the edges include one or more edge data items and corresponding data values, and the apparatus 700 is deployed in a computing device, is configured to store the edges in the relation network in a non-volatile storage, and includes: a second receiving module 710, configured to receive a storage request, where the storage request is used to store a first edge using a first node as a starting node in the storage, and the first edge includes a first edge data item and a corresponding data value; a first storage module 720, co2nfigured to store the first edge in the storage, and determine location information of the first edge; a third acquisition module 730, configured to obtain, from the storage, one or more index blocks associated with the first node; a second determining module 740, configured to determine, from the one or more index blocks based on a correspondence between an index block and an edge data item, a first index block corresponding to the first edge data item; and a first recording module 750, configured to record the data value of the first edge data item and the location information of the first edge in the first index block.

In some implementations, the third acquisition module 730 is specifically configured to: obtain, from the storage, locations to be written of the one or more index blocks associated with the first node; and the second determining module 740 is specifically configured to: determine, from the locations to be written of the one or more index blocks based on the correspondence between an index block and an edge data item, a location to be written of the first index block corresponding to the first edge data item.

In some implementations, the third acquisition module 730 is specifically configured to: search the storage for the first node, and obtain the one or more index blocks associated with the first node based on the identified first node.

In some implementations, the relation network is stored in one or more data layers of the storage, and one of the data layers is used to store a plurality of nodes and one or more associated index blocks, the storage request is used to store the first edge in a first data layer of the storage, and the method is performed for the first data layer.

In some implementations, any one of the data layers is used to store one or more data files, any one of the data files is used to store a plurality of nodes and one or more associated index blocks, the storage request is used to store the first edge in a first data file of the first data layer, and the method is performed for the first data file.

The above-mentioned apparatus embodiments correspond to the method embodiments. For detailed descriptions, references can be made to the descriptions of the method embodiments, and details are omitted here for simplicity. The apparatus embodiments are obtained based on the corresponding method embodiments, and have the same technical effects as the corresponding method embodiments. For detailed descriptions, references can be made to the corresponding method embodiments.

Some embodiments of this specification further provide a computer-readable storage medium. The computer-readable storage medium stores a computer program, and when the computer program is executed in a computer, the computer is enabled to perform the method described in any one of FIG. 1 to FIG. 5.

Some embodiments of this specification further provide a computing device, including a storage and a processor. The storage stores executable code, and when executing the executable code, the processor implements the method described in any one of FIG. 1 to FIG. 5.

The embodiments of this specification are described in a progressive way. For same or similar parts of the embodiments, mutual references can be made to the embodiments. Each embodiment focuses on a difference from other embodiments. Particularly, storage medium embodiments and computing device embodiments are basically similar to the method embodiments, and therefore are described briefly. For related descriptions, references can be made to the descriptions in the method embodiments.

A person skilled in the art should be aware that in the above-mentioned one or more examples, functions described in the embodiments of this application can be implemented by hardware, software, firmware, or any combination thereof. When being implemented by software, these functions can be stored in a computer-readable medium or transmitted as one or more instructions or code in the computer-readable medium.

The objectives, technical solutions, and beneficial effects of the embodiments of this application have been described in more detail with reference to the above-mentioned specific implementations. It should be understood that the above-mentioned descriptions are merely some specific implementations of the embodiments of this application and are not intended to limit the protection scope of this application. Any modification, equivalent replacement, improvement, etc. made based on the technical solutions of this application shall fall within the protection scope of this application.

What is claimed is:

1. A computer-implemented method for relation network data query, comprising:
receiving a query request, wherein the query request is used to query for an edge to be queried using a first node as a starting node, wherein the edge to be queried satisfies a specified filter condition, and the specified filter condition comprises that the edge to be queried has a first edge data item and a corresponding first data value;
obtaining, from a storage storing a relation network, multiple index blocks associated with the first node, wherein the storage is non-volatile, wherein the relation network comprises a plurality of nodes and a plurality of edges connecting the plurality of nodes, and wherein the plurality of edges comprise multiple edge data items and corresponding data values;
determining, from the multiple index blocks based on a correspondence between an index block and an edge data item, a first index block corresponding to the first edge data item, wherein the first index block comprises multiple data values of the first edge data item and location information of edges having the multiple data values and using the first node as starting nodes; and
determining location information of an edge having the corresponding first data value from the first index block and obtaining the edge to be queried from the storage based on the location information of the edge.

2. The computer-implemented method of claim 1, wherein obtaining, from the storage, multiple index blocks associated with the first node, comprises:
obtaining, from the storage, location information of the multiple index blocks associated with the first node; and
determining, from the multiple index blocks based on a correspondence between an index block and an edge data item, a first index block corresponding to the first edge data item comprises:
determining, from the location information of the multiple index blocks based on the correspondence between an index block and an edge data item, location information of the first index block corresponding to the first edge data item; and
obtaining the first index block from the storage based on the location information.

3. The computer-implemented method of claim 1, wherein obtaining, from the storage, multiple index blocks associated with the first node, comprises:
searching the storage for the first node; and
obtaining the multiple index blocks associated with the first node based on the first node.

4. The computer-implemented method of claim 3, wherein:
nodes in the storage are stored based on hash values; and
searching the storage for the first node comprises:
searching for the first node by using a hash value of the first node.

5. The computer-implemented method of claim 1, wherein:
the specified filter condition comprises that the edge to be queried has a plurality of first edge data items and corresponding first data values;
the plurality of first edge data items, respectively, correspond to a plurality of first index blocks; and
determining location information of an edge having the corresponding first data value from the first index block, and obtaining the edge to be queried from the storage based on the location information of the edge, comprises:
respectively determining location information of edges having corresponding first data values from the plurality of first index blocks, to obtain a plurality of groups of edge location information, selecting an intersection set of the plurality of groups of edge location information, to obtain a location information intersection set, and obtaining the edge to be queried from the storage based on the location information intersection set.

6. The computer-implemented method of claim 5, wherein respectively determining location information of edges having corresponding first data values from the plurality of first index blocks, comprises:
respectively determining, through asynchronous query, the location information of the edges having the corresponding first data values from the plurality of first index blocks.

7. The computer-implemented method of claim 1, wherein the relation network is stored in multiple data layers of the storage, any one of the data layers is used to store a plurality of nodes and multiple associated index blocks, an edge that any one index block points to is stored in the data layer.

8. The computer-implemented method of claim 7, wherein obtaining, from the storage, multiple index blocks associated with the first node, comprises:
obtaining, from each data layer of the multiple data layers of the storage, multiple index blocks associated with the first node in a corresponding data layer, to obtain index block groups respectively corresponding to the multiple data layers;
determining, from the multiple index blocks, a first index block corresponding to the first edge data item, comprises:
respectively determining, from multiple index block groups, first index blocks corresponding to first edge data items; and
determining location information of an edge having the corresponding first data value from the first index block, and obtaining the edge to be queried from the storage based on the location information of the edge, comprises:
respectively determining location information of edges having first data values from the first index blocks corresponding to the multiple data layers; and
determining the edge to be queried based on the location information of the edges determined from the multiple data layers.

9. The computer-implemented method of claim 7, wherein any one of the data layers is used to store multiple data files, any one of the data files is used to store a plurality of nodes and multiple associated index blocks, an edge that any one index block points to is stored in the data file.

10. A non-transitory, computer-readable medium storing one or more instructions executable by a computer system to perform one or more operations for relation network data query, comprising:
receiving a query request, wherein the query request is used to query for an edge to be queried using a first node as a starting node, wherein the edge to be queried satisfies a specified filter condition, and the specified filter condition comprises that the edge to be queried has a first edge data item and a corresponding first data value;
obtaining, from a storage storing a relation network, multiple index blocks associated with the first node, wherein the storage is non-volatile, wherein the relation network comprises a plurality of nodes and a plurality of edges connecting the plurality of nodes, and wherein the plurality of edges comprise multiple edge data items and corresponding data values;
determining, from the multiple index blocks based on a correspondence between an index block and an edge data item, a first index block corresponding to the first edge data item, wherein the first index block comprises multiple data values of the first edge data item and location information of edges having the multiple data values and using the first node as starting nodes; and
determining location information of an edge having the corresponding first data value from the first index block and obtaining the edge to be queried from the storage based on the location information of the edge.

11. The non-transitory, computer-readable medium of claim 10, wherein obtaining, from the storage, multiple index blocks associated with the first node, comprises:
obtaining, from the storage, location information of the multiple index blocks associated with the first node; and
determining, from the multiple index blocks based on a correspondence between an index block and an edge data item, a first index block corresponding to the first edge data item comprises:
determining, from the location information of the multiple index blocks based on the correspondence between an index block and an edge data item, location information of the first index block corresponding to the first edge data item; and
obtaining the first index block from the storage based on the location information.

12. The non-transitory, computer-readable medium of claim 10, wherein obtaining, from the storage, multiple index blocks associated with the first node, comprises:
searching the storage for the first node; and
obtaining the multiple index blocks associated with the first node based on the first node.

13. The non-transitory, computer-readable medium of claim 12, wherein:
nodes in the storage are stored based on hash values; and
searching the storage for the first node comprises:
searching for the first node by using a hash value of the first node.

14. The non-transitory, computer-readable medium of claim 10, wherein:
the specified filter condition comprises that the edge to be queried has a plurality of first edge data items and corresponding first data values;
the plurality of first edge data items, respectively, correspond to a plurality of first index blocks; and
determining location information of an edge having the corresponding first data value from the first index block, and obtaining the edge to be queried from the storage based on the location information of the edge, comprises:
respectively determining location information of edges having corresponding first data values from the plurality of first index blocks, to obtain a plurality of groups of edge location information, selecting an intersection set of the plurality of groups of edge location information, to obtain a location information intersection set, and obtaining the edge to be queried from the storage based on the location information intersection set.

15. The non-transitory, computer-readable medium of claim 14, wherein respectively determining location information of edges having corresponding first data values from the plurality of first index blocks, comprises:
respectively determining, through asynchronous query, the location information of the edges having the corresponding first data values from the plurality of first index blocks.

16. The non-transitory, computer-readable medium of claim 10, wherein the relation network is stored in multiple data layers of the storage, any one of the data layers is used to store a plurality of nodes and multiple associated index blocks, an edge that any one index block points to is stored in the data layer.

17. The non-transitory, computer-readable medium of claim 16, wherein obtaining, from the storage, multiple index blocks associated with the first node, comprises:
obtaining, from each data layer of the multiple data layers of the storage, multiple index blocks associated with the first node in a corresponding data layer, to obtain index block groups respectively corresponding to the multiple data layers;
determining, from the multiple index blocks, a first index block corresponding to the first edge data item, comprises:
respectively determining, from multiple index block groups, first index blocks corresponding to first edge data items; and
determining location information of an edge having the corresponding first data value from the first index block, and obtaining the edge to be queried from the storage based on the location information of the edge, comprises:
respectively determining location information of edges having first data values from the first index blocks corresponding to the multiple data layers; and
determining the edge to be queried based on the location information of the edges determined from the multiple data layers.

18. The non-transitory, computer-readable medium of claim 16, wherein any one of the data layers is used to store multiple data files, any one of the data files is used to store a plurality of nodes and multiple associated index blocks, an edge that any one index block points to is stored in the data file.

19. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations for relation network data query, comprising:
receiving a query request, wherein the query request is used to query for an edge to be queried using a first node as a starting node, wherein the edge to be queried satisfies a specified filter condition, and the specified filter condition comprises that the edge to be queried has a first edge data item and a corresponding first data value;
obtaining, from a storage storing a relation network, multiple index blocks associated with the first node, wherein the storage is non-volatile, wherein the relation network comprises a plurality of nodes and a plurality of edges connecting the plurality of nodes, and wherein the plurality of edges comprise multiple edge data items and corresponding data values;
determining, from the multiple index blocks based on a correspondence between an index block and an edge data item, a first index block corresponding to the first edge data item, wherein the first index block comprises multiple data values of the first edge data item and location information of edges having the multiple data values and using the first node as starting nodes; and
determining location information of an edge having the corresponding first data value from the first index block and obtaining the edge to be queried from the storage based on the location information of the edge.

20. The computer-implemented system of claim 19, wherein obtaining, from the storage, multiple index blocks associated with the first node, comprises:
obtaining, from the storage, location information of the multiple index blocks associated with the first node; and
determining, from the multiple index blocks based on a correspondence between an index block and an edge data item, a first index block corresponding to the first edge data item comprises:
determining, from the location information of the multiple index blocks based on the correspondence between an index block and an edge data item, location information of the first index block corresponding to the first edge data item; and
obtaining the first index block from the storage based on the location information.
